(19) United States
(12) Patent Application Publication
(10) Pub. No.: US 2003/0124389 A1
(43) Pub. Date: Jul. 3, 2003

(54) Magnetic recording medium, method of producing magnetic recording medium and storage apparatus

(75) Inventors: Yuki Yoshida, Kawasaki-shi (JP); E. Noel Abarra, Kawasaki-shi (JP); Iwao Okamoto, Kawasaki-shi (JP)

Correspondence Address: Patrick G. Burns, Suite 2500, 300 South Wacker Drive, Chicago, IL, 60606, US

(73) Assignee: Fujitsu Limited

(21) Appl. No.: 10/357,247

(22) Filed: Feb. 3, 2003

Related U.S. Application Data
(63) Continuation of application No. 09/454,622, filed on Dec. 6, 1999, now abandoned.

(30) Foreign Application Priority Data
Jun. 8, 1999 (JP) 11-161328

(51) Int. Cl. H01F 1/00

(52) U.S. Cl. 428/695; 428/611

(57) ABSTRACT

A magnetic recording medium includes a non-magnetic substrate having a top surface subjected to a texturing process in one direction, a seed layer provided on the top surface of the substrate and made of Cr or a Cr-based alloy having a (002) crystal face which is approximately parallel to the top surface of the substrate, an underlayer, provided on the seed layer and having a B2 crystal structure, and a magnetic layer provided above the underlayer, and made of a Co-based alloy.

### BACKGROUND OF THE INVENTION

1. Field of the Invention

The present invention generally relates to magnetic recording mediums, methods of producing magnetic recording mediums, and magnetic storage apparatuses, and more particularly to a magnetic recording medium having a structure suited for making a high-density in-plane recording, a method of producing such a magnetic recording medium, and a magnetic storage apparatus having such a magnetic recording medium.

2. Description of the Related Art

Due to developments in the field of information processing, there are demands to further improve the recording density of magnetic recording media. In order to satisfy such demands, the characteristics required of the magnetic recording medium, in the case of a hard disk, for example, are low noise, high coercivity, high residual magnetization and high resolution.

A conventional magnetic recording medium includes a non-magnetic substrate made of Al or the like, and a magnetic (recording) layer made of a Co-based alloy disposed on the substrate via a Cr layer. In order to reduce the noise level of the magnetic recording medium, it is necessary to make the magnetic grain diameters fine and uniform, and to prevent magnetic interaction among the magnetic grains. Various additives are being studied to realize magnetic grains which satisfy such conditions.

For example, in a magnetic recording medium proposed in a Japanese Laid-Open Patent Application No.7-50008, the magnetic layer includes one or more kinds of elements selected from Nb, Hf, W, Ti and Ta added to Co₇₉Cr₁₃Pt₈, in order to achieve low noise. In addition, in a magnetic recording medium proposed in a Japanese Laid-Open Patent Application No. 63-148411, the magnetic layer uses CoCr as the main component and is added with Ta, Mo or W. A Cr layer is used as an underlayer for the magnetic layer. Because a (002) crystal face of the Cr underlayer has lattice constants which approximately match those of a (11-20) crystal face of Co which forms the magnetic layer, the Cr underlayer helps the magnetic layer achieve the in-plane magnetic anisotropy, thereby improving the in-plane recording characteristic.

On the other hand, the magnetic recording medium proposed in a U.S. Pat. No. 5,693,426 uses an underlayer which is made of NiAl or the like having a B2 crystal structure, so as to make the grains of the Co magnetic layer relatively fine and uniform, in order to obtain a high signal-to-noise (S/N) ratio for the magnetic recording medium. In this case, the lattice constants of the (112) crystal face of the underlayer match those of the (10-10) crystal face of Co which forms the magnetic layer, and the underlayer helps the magnetic layer achieve the in-plane magnetic anisotropy.

As still another method of improving the S/N ratio of the magnetic recording medium, there is a proposed method which carries out a texturing process in a peripheral direction of a disk-shaped non-magnetic substrate, so as to help the Co magnetic layer achieve magnetic anisotropy in the peripheral direction. According to this proposed method, it is possible to improve the residual magnetization and the coercivity in the peripheral direction of the magnetic layer. By making the magnetic layer have the magnetic anisotropy in the peripheral direction, the thermal stability improves, thereby making it possible to obtain desirable characteristics of the magnetic recording medium.

According to results of experiments conducted by the present inventors, both the Cr underlayer and the NiAl underlayer can make the crystallographic axis of Co which forms the magnetic layer to become oriented in-plane. Hence, it was confirmed that the Cr underlayer and the NiAl underlayer are suited for use in the magnetic recording medium which makes in-plane recording. In addition, it was also confirmed that the NiAl underlayer can make the magnetic grains of the magnetic layer become fine and uniform, thereby being effective in reducing the noise.

However, although Co can grow in two directions on the (002) crystal face of Cr, Co can only grow in one direction on the rectangular (112) crystal face of NiAl. For this reason, even if the texturing process is carried out in the peripheral direction with respect to the substrate, it is impossible to make the Co magnetic layer have a magnetic anisotropy in the peripheral direction by use of the NiAl underlayer. In this case, it was confirmed that the texturing process carried out with respect to the substrate cannot bring out the originally desired magnetic characteristics of the magnetic layer.

### SUMMARY OF THE INVENTION

Accordingly, it is a general object of the present invention to provide a novel and useful magnetic recording medium, method of producing magnetic recording medium, and magnetic storage apparatus, in which the problems described above are eliminated.

Another and more specific object of the present invention is to provide a magnetic recording medium having a magnetic layer provided on an underlayer which has a B2 crystal structure and is disposed on a non-magnetic substrate, wherein the magnetic layer is made to have a magnetic anisotropy in one direction so as to improve the recording characteristic and thermal stability, a method of producing such a magnetic recording medium, and a magnetic storage apparatus having such a magnetic recording medium.

Still another object of the present invention is to provide a magnetic recording medium comprising a non-magnetic substrate having a top surface subjected to a texturing process in one direction, a seed layer, provided on the top surface of the substrate, and made of Cr or a Cr-based alloy having a (002) crystal face which is approximately parallel to the top surface of the substrate, an underlayer, provided on the seed layer, and having a B2 crystal structure, and a magnetic layer, provided above the underlayer, and made of a Co-based alloy. According to the magnetic recording medium of the present invention, it is possible to generate magnetic anisotropy in the underlayer by the provision of the seed layer, so as to help achieve magnetic anisotropy in the magnetic layer. As a result, it is possible to improve the recording characteristic and the thermal stability of the magnetic recording medium.

A further object of the present invention is to provide a method of producing a magnetic recording medium comprising (a) carrying out a texturing process in one direction with respect to a top surface of a non-magnetic substrate, (b) forming a seed layer on the top surface of the substrate, the seed layer being made of Cr or a Cr-based alloy having a (002) crystal face which is approximately parallel to the top surface of the substrate, (c) forming an underlayer having a B2 crystal structure on the seed layer, and (d) forming a magnetic layer made of a Co-based alloy above the underlayer. According to the method of producing magnetic recording medium of the present invention, it is possible to generate magnetic anisotropy in the underlayer by the provision of the seed layer, so as to help achieve magnetic anisotropy in the magnetic layer. As a result, it is possible to improve the recording characteristic and the thermal stability of the magnetic recording medium.

Another object of the present invention is to provide a magnetic storage apparatus comprising at least one magnetic recording medium, and a head recording information on and reproducing information from the magnetic recording medium, where the magnetic recording medium comprises a non-magnetic substrate having a top surface subjected to a texturing process in one direction, a seed layer, provided on the top surface of the substrate, and made of Cr or a Cr-based alloy having a (002) crystal face which is approximately parallel to the top surface of the substrate, an underlayer, provided on the seed layer, and having a B2 crystal structure, and a magnetic layer, provided above the underlayer, and made of a Co-based alloy. According to the magnetic storage apparatus of the present invention, it is possible to generate magnetic anisotropy in the underlayer by the provision of the seed layer, so as to help achieve magnetic anisotropy in the magnetic layer. As a result, it is possible to improve the recording characteristic and the thermal stability of the magnetic recording medium.

Other objects and further features of the present invention will be apparent from the following detailed description when read in conjunction with the accompanying drawings.

### BRIEF DESCRIPTION OF THE DRAWINGS

FIG. 1 is a cross sectional view showing an important part of an embodiment of a magnetic recording medium according to the present invention;

FIG. 2 is a flow chart for explaining an embodiment of a method of producing a magnetic recording medium according to the present invention;

FIG. 3 is a diagram showing normalized noise of a magnetic recording medium 100 at 200 kfci with respect to the thickness of a NiAl underlayer;

FIG. 4 is a diagram showing plotted results of orientation ratio of the magnetic recording medium 100 with respect to the thickness of the NiAl underlayer;

FIG. 5 is a diagram showing a ratio of an output and a solitary wave output of the magnetic recording medium 100 at the recording density of 200 kfci with respect to the thickness of the NiAl underlayer;

FIG. 6 is a diagram showing normalized noise of a magnetic recording medium 10 at 200 kfci with respect to the thickness of a NiAl underlayer;

FIG. 7 is a diagram showing plotted results of orientation ratio of the magnetic recording medium 10 with respect to the thickness of a CrMo seed layer;

FIG. 8 is a diagram showing a ratio of an output and a solitary wave output of the magnetic recording medium 10 at the recording density of 200 kfci with respect to the thickness of the CrMo seed layer;

FIG. 9 is a diagram showing a SIN ratio of the magnetic recording medium 10 at the high recording density of 200 kfci with respect to the thickness of the CrMo seed layer;

FIGS. 10A and 10B respectively are diagrams showing crystal orientations of a sample not provided with a CrMo seed layer and a sample provided with the CrMo seed layer;

FIG. 11 is a diagram showing changes in residual magnetizations with time of magnetic recording media under conditions which are the same except for the magnetic anisotropy; and

FIG. 12 is a plan view showing an important part of an embodiment of a magnetic storage apparatus according to the present invention.

### DESCRIPTION OF THE PREFERRED EMBODIMENTS

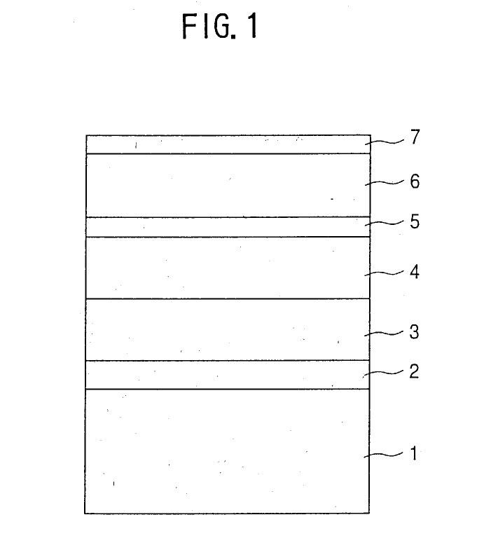

FIG. 1 is a cross sectional view showing an important part of an embodiment of a magnetic recording medium according to the present invention. The magnetic recording medium shown in FIG. 1 generally includes a non-magnetic substrate 1, a seed layer 2, an underlayer 3, a first intermediate layer 4, a second intermediate layer 5, a magnetic layer 6, and a protection layer 7.

The non-magnetic substrate 1 is made of NiP or Al, for example, and is subjected to a texturing process in one direction or a correspondingly appropriate direction, so as to give a magnetic anisotropy in this one direction. In a case where the magnetic recording medium is a magnetic disk, this one direction corresponds to a direction in which tracks of the magnetic disk extend, that is, a peripheral direction of the magnetic disk.

For example, the seed layer 2 is made of Cr or a Cr-based alloy which is selected from a group of CrMo, CrW, CrTi, CrV, CrCu and CrAl.

The underlayer 3 is made of a material selected from a group of NiAl, FeAl, AlCo, FeTi, CoFe, CoTi, CoHf, CoZr, NiTi, CuBe, CuZn, AlMn, AlRe, AgMg and Ni₂FeMn₂, for example. The underlayer 3 may include 1 to 10% of one or more kinds of materials selected from a group of Cr, Hf, Nb, Ta, V and Zr.

The first intermediate layer 4 is made of Cr or a Cr-based alloy, for example. The Cr-based alloy used for this first intermediate layer 4 may be selected from a group of CrMo, CrW, CrTi, CrV, CrCu and CrAl.

The second intermediate layer 5 is made of a non-magnetic Co-based alloy having a hcp crystal structure, for example. The Co-based alloy used for this second intermediate layer 5 may be selected from a group of CoCr, CoCrMo, CoCrTa and CoCrNb.

For example, the magnetic layer 6 is made of a magnetic material selected from a group of CoCrPt, CoCrPtB, CoCrTa, CoCrPtTa and CoCrPtTaNb.

The protection layer 7 is made of C or the like, for example.

The (002) crystal face of the seed layer 2 which is made of Cr or a Cr-based alloy, is approximately parallel to a top face of the non-magnetic substrate 1. By providing this seed layer 2 between the non-magnetic substrate 1 and the underlayer 3 which is made of the above described material and has the B2 crystal structure, magnetic anisotropy is also generated in the underlayer 3. As a result, the magnetic anisotropy of the underlayer 3 helps achieving magnetic anisotropy in the magnetic layer 6 which is disposed above the underlayer 3. Consequently, it is possible to realize a magnetic recording medium having a high S/N ratio and a satisfactory thermal stability, by a combination of the control of the magnetic grain diameter of the magnetic layer 6 by the underlayer 3 which has the B2 crystal structure and the magnetic anisotropy achieved in one direction by the texturing process carried out with respect to the non-magnetic substrate 1.

It is desirable that the underlayer 3 is made of a material having the B2 crystal structure, such as the materials described above. When the underlayer 3 is made of one of the materials described above, the lattice constants of the underlayer 3 approximately match the lattice constants of the seed layer 2, thereby making it convenient for correctly growing the magnetic layer 6 above the underlayer 3. In addition, since the above described materials used for the underlayer 3 are sick or brittle, thereby causing particle generation within a sputtering chamber upon formation of the underlayer 3, it is possible to soften the underlayer 3 by adding 1 to 10% of one or more kinds of materials selected from a group of Cr, Hf, Nb, Ta, V and Zr.

The thickness of the seed layer 2 must be set so as to be sufficiently large in order to enable the underlayer 3 to grow satisfactorily on the seed layer 2, but not excessively large in order to prevent reduction of the magnetic anisotropy. In this embodiment, the thickness of the seed layer 2 is set in a range of 1 to 50 nm, and preferably in a range of 1 to 30 nm.

The crystal orientation of the underlayer 3 and thus the crystal orientation of the magnetic layer 6 becomes poor if the underlayer 3 is too thin. On the other hand, large undulations are formed on the surface of the underlayer 3 and thus on the surface of the magnetic layer 6 if the underlayer 3 is too thick, and in this case, the possibility of a head hitting the surface of the magnetic recording medium increases. Hence, the thickness of the underlayer 3 is set in a range of 5 to 100 nm in this embodiment.

When the magnetic layer 6 is made of the magnetic materials described above, it is possible to obtain a magnetic layer having a high coercivity and a satisfactory magnetic isolation among the magnetic grains. It is desirable to provide the protection layer 7 on the magnetic layer 6, in order to protect the magnetic layer 6 from corrosion and contact of the head with the surface of the magnetic recording medium.

To be precise, the lattice spacings of the magnetic layer 6 and the underlayer 3 do not perfectly match. Hence, it is desirable to provide the first intermediate layer 4 between the underlayer 3 and the magnetic layer 6, as in this embodiment. The crystal orientation of the first intermediate layer 4 and thus the crystal orientation of the magnetic layer 6 becomes poor if the first intermediate layer 4 is too thin. But on the other hand, if the first intermediate layer 4 is too thick, the magnetic grain diameter of the magnetic layer 6 increases, and the magnetic anisotropy generated in the magnetic layer 6 by the texturing process carried out on the non-magnetic substrate 1 is reduced. For this reason, the thickness of the first intermediate layer 4 is desirably set in a range of 5 to 50 nm in this embodiment. Furthermore, in order to finely adjust the lattice spacings between the seed layer 2 and the first intermediate layer 4, it is desirable to add an element such as Mo, W, Ti, V, Cu and Al when using a Cr-based alloy for the first intermediate layer 4.

In addition, in order not to lose the effects of controlling the magnetic grain diameter of the magnetic layer 6 by the underlayer 3 having the B2 crystal structure, it is desirable to provide the second intermediate layer 5 immediately under the magnetic layer 6, as in this embodiment. The crystal orientation of the second intermediate layer 5 and thus the crystal orientation of the magnetic layer 6 becomes poor if the second intermediate layer 5 is too thin. But on the other hand, if the second intermediate layer 5 is too thick, the magnetic grain diameter of the magnetic layer 6 increases, and the magnetic anisotropy generated in the magnetic layer 6 by the texturing process carried out on the non-magnetic substrate 1 is reduced. For this reason, the thickness of the second intermediate layer 5 is desirably set in a range of 1 to 10 nm in this embodiment.

In a magnetic recording medium including an underlayer which is made of NiAl or the like and has the B2 crystal structure, and a magnetic layer which is made of a Co-based alloy, the effects of controlling the crystal orientation and the magnetic grain diameter of the magnetic layer are obtained by the provision of the underlayer, but it was impossible to obtain the effects of generating the magnetic anisotropy in the magnetic layer by the texturing process carried out with respect to a substrate in one direction.

On the other hand, according to this embodiment, the effects achieved by the provision of the underlayer 3 having the B2 crystal structure are obtainable, and in addition, it is possible to also obtain the effects of generating the magnetic anisotropy in the magnetic layer 6 by the texturing process carried out with respect to the non-magnetic substrate 1. As a result, it is possible to realize a magnetic recording medium having a high S/N ratio.

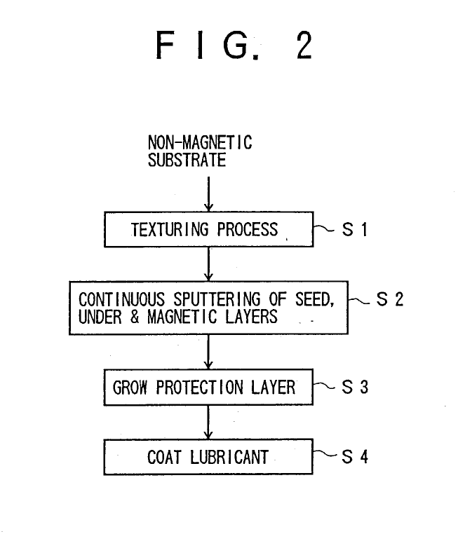

Next, a description will be given of an embodiment of a method of producing a magnetic recording medium according to the present invention. FIG. 2 is a flow chart for explaining this embodiment of the method of producing the magnetic recording medium according to the present invention.

In FIG. 2, a step S1 carries out a known texturing process in one direction with respect to a non-magnetic substrate 1 which is made of NiP or Al. For example, the texturing process forms grooves on the non-magnetic substrate 1 in one direction. A step S2 uses a DC magnetron sputtering apparatus, and heats the non-magnetic substrate 1 which has been subjected to the texturing process to 220° C. In addition, the step S2 successively grows a Cr₉₀Mo₁₀ seed layer 2, a NiAl underlayer 3, a Cr₉₀Mo₁₀ first intermediate layer 4, and a CoCrPtTa magnetic layer 6 on the non-magnetic substrate 1 by continuous sputtering, by setting an Ar gas pressure to 5 mTorr. In this embodiment, no second intermediate layer 5 is formed for the sake of convenience in order to simplify the description. A step S3 grows a C protection layer 7 by setting the Ar gas pressure to 8 mTorr. Then, a step S4 coats a lubricant on the C protection layer 7.

Prior to the sputtering step for each layer, a sputtering chamber was exhausted to 5×10⁻⁸ Torr or less. In addition, for comparison purposes, a magnetic recording medium having no CrMo seed layer 2 was also produced.

In the following description, the magnetic recording medium produced by this embodiment of the method will be referred to as a magnetic recording medium 10, and the magnetic recording medium having no CrMo seed layer 2 will be referred to as a magnetic recording medium 100.

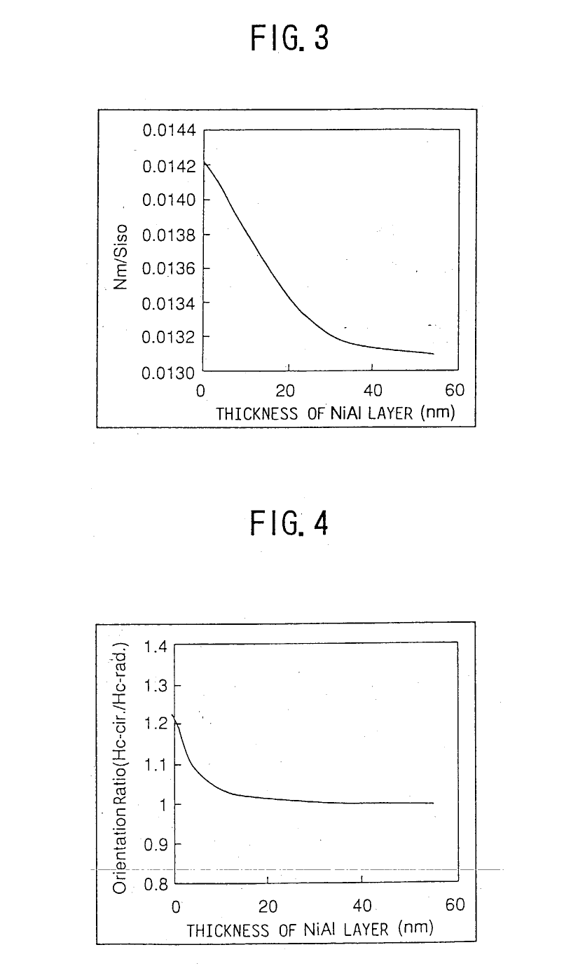

First, the present inventors conducted experiments with respect to the magnetic recording medium 100, and measured the electromagnetic conversion characteristic by use of a giant magneto-resistive (GMR) head. FIG. 3 is a diagram showing the normalized noise of the magnetic recording medium 100 at 200 kfci with respect to the thickness of the NiAl underlayer. It was found from FIG. 3 that the magnetic grain diameter of the magnetic layer is controlled and the noise is reduced by use of the NiAl underlayer, and the effectiveness of the NiAl underlayer was confirmed.

Next, the orientation ratio (OR) in a direction perpendicular to the direction in which the texturing process is carried out with respect to the non-magnetic substrate was obtained. More particularly, the non-magnetic substrate used was disk-shaped, and the orientation ratio in a radial direction of the disk-shaped non-magnetic substrate was obtained. This radial direction is perpendicular to a peripheral direction of the disk-shaped non-magnetic substrate, where the peripheral direction is parallel to the direction in which the texturing process is carried out. When the coercivity is denoted by Hc, the orientation ratio OR is defined as OR=Hc (in peripheral direction)/Hc (in radial direction). FIG. 4 is a diagram showing plotted results of the orientation ratio of the magnetic recording medium 100 with respect to the thickness of the NiAl underlayer. As may be seen from FIG. 4, the magnetic anisotropy in the peripheral direction generated by the texturing process carried out with respect to the disk-shaped non-magnetic substrate is lost by the provision of the NiAl-underlayer. Hence, it was confirmed that the magnetic recording medium becomes magnetically isotropic in both the peripheral direction and the radial direction.

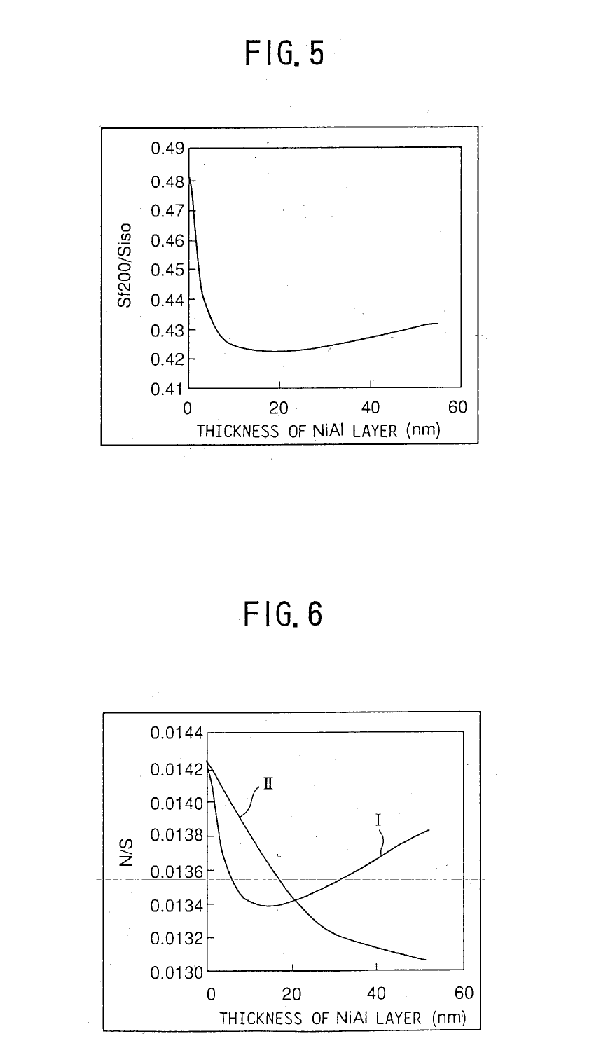

FIG. 5 is a diagram showing a ratio of an output and a solitary wave output of the magnetic recording medium 100 at the recording density of 200 kfci with respect to the thickness of the NiAl underlayer. As may be seen from FIG. 5, when the NiAl underlayer is provided, the output at the high recording density decreases and the resolution decreases as compared to a case where no NiAl underlayer is provided, and consequently, it was confirmed that the recording characteristic of the magnetic recording medium 100 at the high recording density deteriorates.

Next, the present inventors conducted experiments with respect to the magnetic recording medium 10 which is provided with the CrMo seed layer 2 having the thickness of 5 nm under the NiAl underlayer 3, and measured the electromagnetic conversion characteristic by use of the GMR head. FIG. 6 is a diagram showing the normalized noise of the magnetic recording medium 10 at 200 kfci with respect to the thickness of the NiAl underlayer. In FIG. 6, a characteristic I indicates the characteristic of the magnetic recording medium 10, and for comparison purposes, a characteristic II indicates the characteristic of the magnetic recording medium 100. As may be seen from the characteristic I, it was confirmed that the noise reducing effect of the NiAl underlayer 3 is not lost even when the CrMo seed layer 2 is provided.

Next, the orientation ratio (OR) in a direction perpendicular to the direction in which the texturing process is carried out with respect to the non-magnetic substrate 1 was obtained. More particularly, the non-magnetic substrate 1 used was disk-shaped, and the orientation ratio in a radial direction of the disk-shaped non-magnetic substrate 1 was obtained. This radial direction is perpendicular to a peripheral direction of the disk-shaped non-magnetic substrate 1, where the peripheral direction is parallel to the direction in which the texturing process is carried out. When the coercivity is denoted by Hc, the orientation ratio OR is defined as OR=He (in peripheral direction)/Hc (in radial direction).

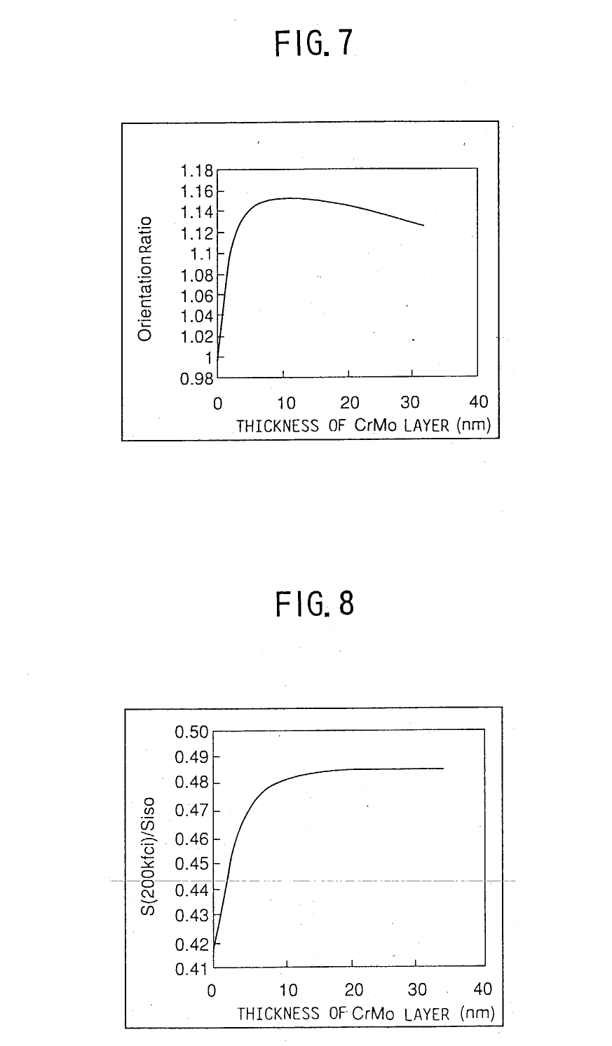

FIG. 7 is a diagram showing plotted results of the orientation ratio of the magnetic recording medium 10 with respect to the thickness of the CrMo seed layer 2. In FIG. 4 described above, the magnetic anisotropy in the peripheral direction generated by the texturing process carried out with respect to the disk-shaped non-magnetic substrate is lost by the provision of the NiAl underlayer, and the orientation ratio is approximately 1. But as may be seen from FIG. 7, it was confirmed that the magnetic anisotropy in the peripheral direction generated by the texturing process carried out with respect to the disk-shaped non-magnetic substrate 1 is maintained and that the orientation ratio is maintained to a high value, by the provision of the CrMo seed layer 2 under the NiAl underlayer 3.

FIG. 8 is a diagram showing a ratio of an output and a solitary wave output of the magnetic recording medium 10 at the recording density of 200 kfci with respect to the thickness of the CrMo seed layer 2. As may be seen from FIG. 8, it was confirmed that the resolution improves and that the disadvantages described in conjunction with FIG. 5 caused by the provision of the NiAl underlayer 3 are eliminated when the CrMo seed layer 2 is provided. In other words, it was confirmed that the recording characteristic of the magnetic recording medium 10 at the high recording density is improved as compared to that of the magnetic recording medium 100.

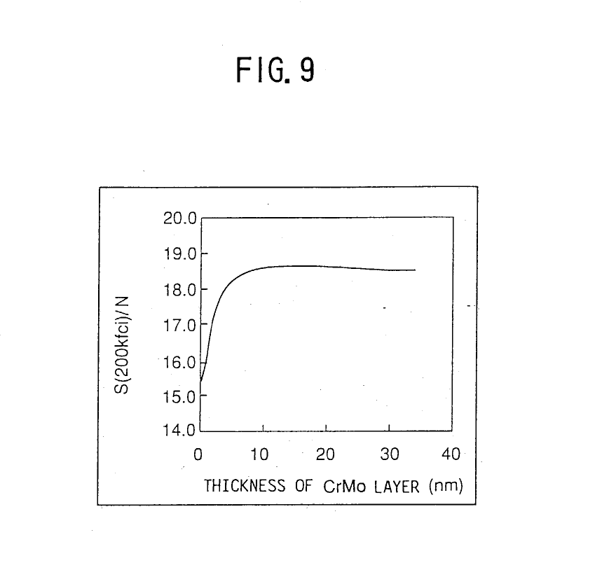

FIG. 9 is a diagram showing the S/N ratio of the magnetic recording medium 10 at the high recording density of 200 kfci with respect to the thickness of the CrMo seed layer 2. As may be seen from FIG. 9, it was confirmed that the S/N ratio is greatly improved by the provision of the CrMo seed layer 2.

According to the experiments conducted by the present inventors, it was found that magnetic recording media 10 having especially good characteristics can be produced when each layer of the magnetic recording media are grown within a temperature range of 150 to 350° C.

Furthermore, the present inventors used a DC magnetron sputtering apparatus to produce a sample 11. This sample 11 was produced by heating a disk-shaped NiP or Al non-magnetic substrate 1 which has been subjected to a texturing process in the peripheral direction to 240° C., and successively growing on the non-magnetic substrate 1 a Cr₉₀Mr₁₀ seed layer 2 having a thickness of 10 nm and a NiAl underlayer 3 having a thickness of 30 nm.

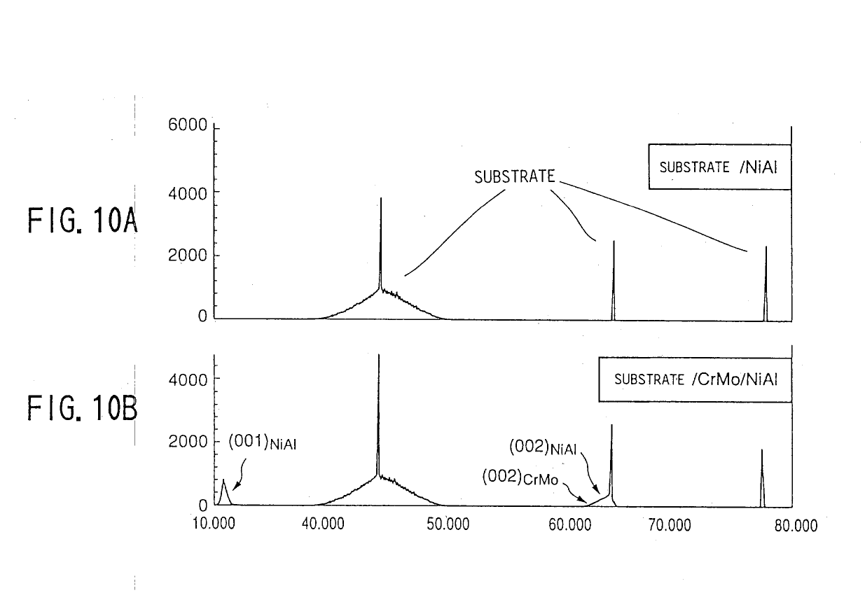

The crystal orientation of this sample 11 was examined by use of a XRD apparatus. Similarly, the crystal orientation of a sample 12 having no CrMo seed layer was examined. FIGS. 10A and 10B respectively are diagrams showing the crystal orientations of the sample 12 not provided with the CrMo seed layer and the sample 11 provided with the CrMo seed layer 2. As may be seen from FIG. 10A, the (001) crystal face or the (002) crystal face of the NiAl underlayer does not grow parallel to the substrate surface of the non-magnetic substrate in the case of the sample 12. On the other hand, it was confirmed that the (001) crystal face of the NiAl underlayer 3 grows approximately parallel to the substrate surface of the non-magnetic substrate 1 in the case of the sample 11, as may be seen from FIG. 10B. In other words, it was confirmed that the crystal orientation of the NiAl underlayer 3 is controlled, and that the magnetic anisotropy generated by the texturing process carried out with respect to the non-magnetic substrate 1 is maintained, by the provision of the CrMo seed layer 2.

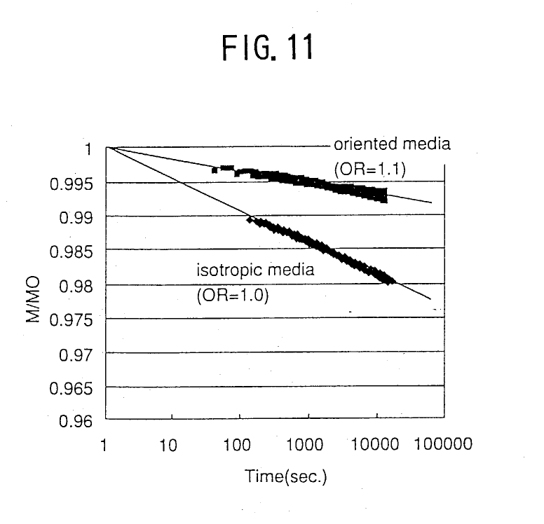

FIG. 11 is a diagram showing changes in the residual magnetizations with time of magnetic recording media under conditions which are the same except for the magnetic anisotropy. In FIG. 11, a characteristic III belongs to a magnetic recording medium having an orientation ratio of 1.1 and having magnetic anisotropy, while a characteristic IV belongs to a magnetic recording medium having an orientation ratio of 1.0 and having no magnetic anisotropy. As may be seen from FIG. 11, the thermal decrease of the magnetization for the characteristic III is small compared to that of the characteristic IV. In other words, it may be seen that the magnetic recording medium becomes thermally stable by having the magnetic anisotropy.

Therefore, according to the magnetic recording medium which is produced by this embodiment of the method, it is possible to carry out a high-density recording because the S/N ratio is improved by the improved resolution and the thermal stability is also improved.

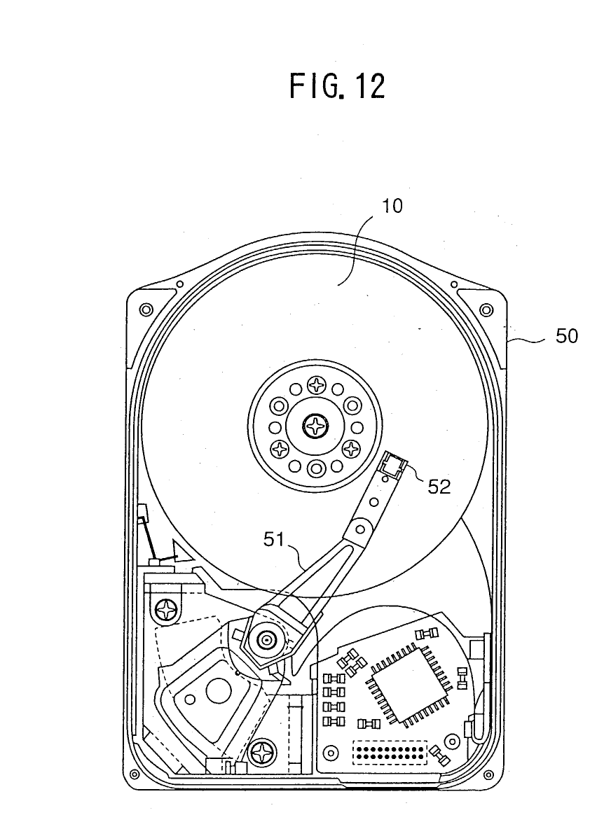

FIG. 12 is a plan view showing an important part of an embodiment of a magnetic storage apparatus according to the present invention. The magnetic storage apparatus shown in FIG. 12 generally includes a housing 50, a plurality of arms 51, a recording and reproducing head 52 provided at the tip end of each arm 51, and a plurality of magnetic recording media 10. FIG. 12 shows a state where a lid (not shown) which seals the upper portion of the housing 50 is removed. The recording and reproducing head 52 has a known construction including a reproducing head portion such as a magneto-resistive (MR) head or a GMR head, and a recording head portion such as an inductive head. A detailed description of the basic construction of the magnetic storage apparatus shown in FIG. 12 will be omitted since the basic construction itself is known. This embodiment of the magnetic storage apparatus is characterized by the structure of the magnetic recording media 10.

The basic construction of the magnetic storage apparatus to which the magnetic recording medium according to the present invention may be applied, is of course not limited to that shown in FIG. 12, and the magnetic recording medium according to the present invention is similarly applicable to various magnetic storage apparatuses having other constructions.

In addition, in the described embodiment, the magnetic layer 6 may have a single-layer structure which is made up solely of one layer or, a multi-layer structure which is made up of a plurality of layers. Similarly, the protection layer 7 may also have a single-layer structure or a multi-layer structure.

Further, the present invention is not limited to these embodiments, but various variations and modifications may be made without departing from the scope of the present invention.

What is claimed is:

1. A magnetic recording medium comprising:
a non-magnetic substrate having a top surface subjected to a texturing process in one direction;
a seed layer, provided on the top surface of said substrate, and made of Cr or a Cr-based alloy having a (002) crystal face which is approximately parallel to the top surface of said substrate;
an underlayer, provided on said seed layer, and having a B2 crystal structure; and
a magnetic layer, provided above said underlayer, and made of a Co-based alloy.

2. The magnetic recording medium as claimed in claim 1, wherein said seed layer is made of a Cr-based alloy selected from a group of CrMo, CrW, CrTi, CrV, CrCu and CrAl.

3. The magnetic recording medium as claimed in claim 1, wherein said underlayer is made of a material selected from a group of NiAl, FeAl, AlCo, FeTi, CoFe, CoTi, CoHf, CoZr, NiTi, CuBe, CuZn, AlMn, AlRe, AgMg and Ni₂FeMn₂.

4. The magnetic recording medium as claimed in claim 3, wherein said underlayer includes 1 to 10% of one or more kinds of materials selected from a group of Cr, Hf, Nb, Ta, V and Zr.

5. The magnetic recording medium as claimed in claim 1, wherein said magnetic layer is made of a material selected from a group of CoCrPt, CoCrPtB, CoCrTa, CoCrPtTa and CoCrPtTaNb.

6. The magnetic recording medium as claimed in claim 1, which further comprises:
a first intermediate layer, provided between said underlayer and said magnetic layer, and made of Cr or a Cr-based alloy.

7. The magnetic recording medium as claimed in claim 6, wherein said first intermediate layer is made of a Cr-based alloy selected from a group of CrMo, CrW, CrTi, CrV, CrCu and CrAl.

8. The magnetic recording medium as claimed in claim 6, wherein said first intermediate layer has a thickness of 5 to 50 nm.

9. The magnetic recording medium as claimed in claim 6, wherein said first intermediate layer is provided on said underlayer, and further comprising:
a second intermediate layer, provided between said first intermediate layer and said magnetic layer, and made of a non-magnetic Co-based alloy having a hcp crystal structure.

10. The magnetic recording medium as claimed in claim 9, wherein said second intermediate layer is made of a Co-based alloy selected from a group of CoCr, CoCrMo, CoCrTa and CoCrNb.

11. The magnetic recording medium as claimed in claim 9, wherein said second intermediate layer has a thickness of 1 to 10 nm.

12. The magnetic recording medium as claimed in claim 1, wherein said seed layer has a thickness of 1 to 50 nm.

13. A method of producing a magnetic recording medium comprising:
(a) carrying out a texturing process in one direction with respect to a top surface of a non-magnetic substrate;
(b) forming a seed layer on the top surface of said substrate, said seed layer being made of Cr or a Cr-based alloy having a (002) crystal face which is approximately parallel to the top surface of said substrate;
(c) forming an underlayer having a B2 crystal structure on said seed layer; and
(d) forming a magnetic layer made of a Co-based alloy above said underlayer.

14. The method of producing magnetic recording medium as claimed in claim 13, wherein said step (b) forms said seed layer from a Cr-based alloy selected from a group of CrMo, CrW, CrTi, CrV, CrCu and CrAl.

15. The method of producing magnetic recording medium as claimed in claim 13, wherein said step (c) forms said underlayer from a material selected from a group of NiAl, FeAl, AlCo, FeTi, CoFe, CoTi, CoHf, CoZr, NiTi, CuBe, CuZn, AlMn, AlRe, AgMg and Ni₂FeMn₂.

16. The method of producing magnetic recording medium as claimed in claim 13, wherein said step (d) forms said magnetic layer from a material selected from a group of CoCrPt, CoCrPtB, CoCrTa, CoCrPtTa and CoCrPtTaNb.

17. A magnetic storage apparatus comprising:
at least one magnetic recording medium; and
a head recording information on and reproducing information from said magnetic recording medium,
said magnetic recording medium comprising:
a non-magnetic substrate having a top surface subjected to a texturing process in one direction;
a seed layer, provided on the top surface of said substrate, and made of Cr or a Cr-based alloy having a (002) crystal face which is approximately parallel to the top surface of said substrate;
an underlayer, provided on said seed layer, and having a B2 crystal structure; and
a magnetic layer, provided above said underlayer, and made of a Co-based alloy.

18. The magnetic storage apparatus as claimed in claim 17, wherein said seed layer of said magnetic recording medium is made of a Cr-based alloy selected from a group of CrMo, CrW, CrTi, CrV, CrCu and CrAl.

19. The magnetic storage apparatus as claimed in claim 17, wherein said underlayer of said magnetic recording medium is made of a material selected from a group of NiAl, FeAl, AlCo, FeTi, CoFe, CoTi, CoHf, CoZr, NiTi, CuBe, CuZn, AlMn, AlRe, AgMg and Ni₂FeMn₂.

20. The magnetic storage apparatus as claimed in claim 17, wherein said magnetic layer of said magnetic recording medium is made of a material selected from a group of CoCrPt, CoCrPtB, CoCrTa, CoCrPtTa and CoCrPtTaNb.
